(19) United States
(12) Patent Application Publication
(10) Pub. No.: US 2025/0355673 A1
(43) Pub. Date: Nov. 20, 2025

(54) BIOS SETUP SERVICE METHOD, COMPUTER DEVICE AND NON-TRANSITORY COMPUTER-READABLE STORAGE MEDIUM

(71) Applicant: INSYDE SOFTWARE CORP., Taipei City (TW)

(72) Inventors: TE-YU TZENG, Taipei City (TW); HAO-WEI CHENG, Taipei City (TW); PAO-KUANG LAI, Taipei City (TW)

(73) Assignee: INSYDE SOFTWARE CORP., Taipei City (TW)

(21) Appl. No.: 18/815,867

(22) Filed: Aug. 27, 2024

(30) Foreign Application Priority Data
May 17, 2024 (TW) 113118462
May 29, 2024 (TW) 113119832

(51) Int. Cl. G06F 9/4401; G06F 16/332

(52) U.S. Cl. CPC G06F 9/4401; G06F 16/3329

(57) ABSTRACT

BIOS setup service method, computer device and non-transitory computer-readable storage medium are provided. The BIOS setup service method includes: receiving a natural language inquiry from a user; providing the natural language inquiry and system configuration information related to the computer device to an artificial intelligence engine, so that the artificial intelligence engine generates a response output according to the natural language inquiry and the system configuration information; receiving the response output from the artificial intelligence engine, the response output including a natural language response field; and providing the user with a natural language response in the natural language response field.

### CROSS-REFERENCE TO RELATED APPLICATION

This non-provisional application claims priority under 35 U.S.C. § 119 (a) on Patent Application No(s). 113118462 filed in Taiwan, R.O.C. on May 17, 2024, and on Patent Application No(s). 113119832 filed in Taiwan, R.O.C. on May 29, 2024, the entire contents of which are hereby incorporated by reference.

### BACKGROUND OF THE INVENTION

### 1. Field of the Invention

The present disclosure relates to a setup service method and device, and in particular to a BIOS setup service method, a computer device and a non-transitory computer-readable storage medium.

### 2. Description of the Related Art

In a current computer device, regarding a method carried out by the Basic Input/Output System (BIOS) for adjusting any setting, a selection is made from a series of options in a menu in a BIOS setting interface (a text interface) to complete the adjustment. The menu containing the series of options includes control options for various adjustable settings, for example, multiple selection boxes, drop-down lists of options, and numerical/text/data input boxes. Each control option controls only one setting, is placed in multiple pages or sub-menus, and usually has a special name difficult for a user to comprehend. Since the BIOS setting interface is presented in the form of text/menu, a user may face the following issues if adjustment to any setting of the BIOS is desired: the user is unable to find the page or sub-menu where the control option of the setting to be modified is located, and/or the user does not comprehend the special name of each control option and has no way to learn which control option is to be used for adjusting what BIOS setting. Thus, the user is unknowledgeable of which settings need to be modified in order to solve target issues, resulting in difficulties in use. Moreover, certain physically challenged users (for example, visually impaired users) are unable to adjust BIOS settings on a BIOS setting interface presented in the form of text/menu.

Therefore, it is an object of the present disclosure to provide a solution for solving the above issues of the prior art.

### BRIEF SUMMARY OF THE INVENTION

It is an object of the present disclosure to provide a Basic Input/Output System (BIOS) setup service method for overcoming the issues of the prior art.

A BIOS setup service method of the present disclosure is adapted for a computer device, and includes steps of: (A) receiving a natural language inquiry from a user; (B) providing the natural language inquiry and system configuration information related to the computer device to an artificial intelligence engine, so that the artificial intelligence engine generates a response output according to the natural language inquiry and the system configuration information; (C) receiving the response output from the artificial intelligence engine, the response output including a natural language response field; and (D) providing the user with a natural language response in the natural language response field.

In some embodiments, in step (C), the response output includes the natural language response field and/or a BIOS command field, and step (D) further includes executing a BIOS setting adjustment command in the BIOS command field to adjust a BIOS setting.

In some embodiments, in step (D), the BIOS setting is adjusted through a Windows Management Instrumentation (WMI), a Device Firmware Configuration Interface (DFCI), changing a variable or a Human Interface Infrastructure (HII) Setup Data Hub.

In some embodiments, in step (A), the natural language inquiry is in a text, voice, graphic or video format.

In some embodiments, in step (D), the natural language response is in a text, voice or graphic format.

In some embodiments, the natural language inquiry is a BIOS setting adjustment inquiry and/or data inquiry related to use of the computer device.

In some embodiments, the system configuration information includes BIOS information and/or Unified Extensible Firmware Interface (UEFI) information.

In some embodiments, the artificial intelligence engine is located within the computer device or is disposed at a cloud, and is a trained or untrained artificial intelligence engine.

In some embodiments, in step (D), the natural language response is transmitted to another device outside the computer device.

It is another object of the present disclosure to provide a computer device and a non-transitory computer-readable storage medium capable of overcoming the issues of the prior art.

The computer device includes: a BIOS, having system configuration information related to the computer device; and a user interface, communicatively connected to the BIOS to acquire the system configuration information, operable to perform the BIOS setup service method above.

The non-transitory computer-readable storage medium has multiple instructions stored therein, wherein the computer device above, after reading the instructions, is enabled to perform the BIOS setup service method above.

The present disclosure achieves the following effects. By using the BIOS setup service method to directly interact with the BIOS using a natural language, all settings of the computer device can be controlled by a single control means (the natural language). Moreover, certain physically challenged users (for example, visually impaired users) are allowed to adjust the BIOS settings through directly interacting with the BIOS by the natural language using a natural language inquiry in a voice format, and acquire a natural language response output in a voice format from the user interface. Thus, issues or requirements of users are solved or fulfilled, and an effect of providing users with ease of use is also achieved.

### BRIEF DESCRIPTION OF THE DRAWINGS

FIG. 1 is a block diagram of a computer device according to an embodiment of the present disclosure.

FIG. 2 is a flowchart of a BIOS setup service method implemented according to the embodiment of the present disclosure.

FIG. 3 is a schematic diagram of a format of a natural language inquiry and system configuration information of the embodiment.

FIG. 4 is a schematic diagram of a format of a response output of the embodiment.

### DETAILED DESCRIPTION OF THE INVENTION

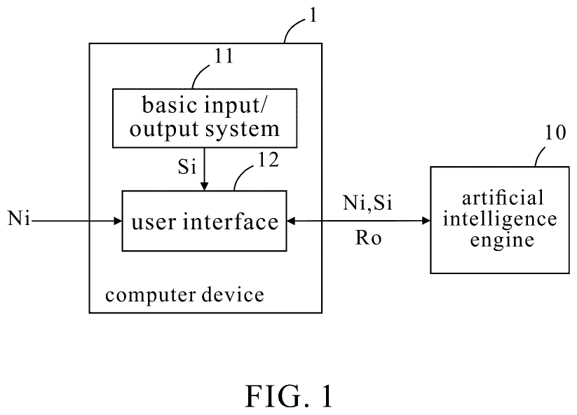

Refer to FIG. 1 showing a computer device 1 according to an embodiment of the present disclosure. The computer device 1 includes a Basic Input/Output System (BIOS) 11 and a user interface 12. The computer device 1 is, for example, a tablet computer, a laptop computer or a desktop computer.

The BIOS 11 has system configuration information Si related to the computer device 1. The system configuration information Si includes BIOS information and/or Unified Extensible Firmware Interface (UEFI) information. The user interface 12 is communicatively connected to the BIOS 11 so as to acquire the system configuration information Si.

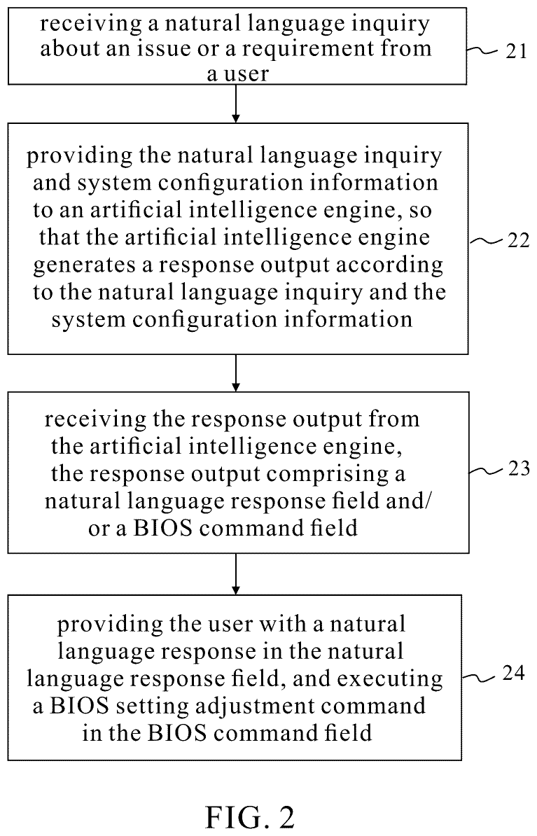

Further refer to FIG. 2 showing a flowchart of a BIOS setup service method of the present disclosure performed by the computer device 1. The BIOS setup service method of the present disclosure includes steps 21 to 24 below.

In step 21, the user interface 12 receives a natural language inquiry Ni about an issue or a requirement from a user. The natural language inquiry Ni is a BIOS setting adjustment inquiry and/or data inquiry related to the use of the computer device 1 (for example, an inquiry about the system time of the computer device 1). The natural language inquiry Ni is in a text, voice, graphic or video format, or in other formats capable of representing the natural language inquiry.

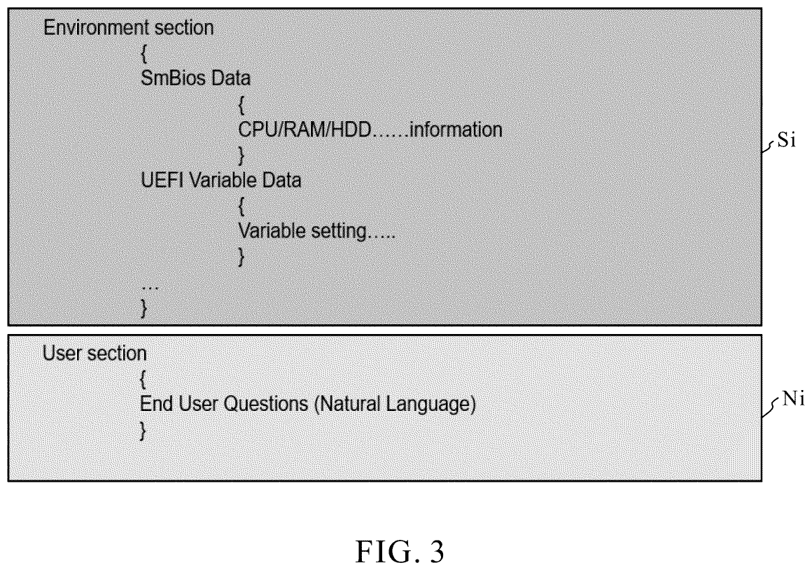

In step 22, the user interface 12 provides the natural language inquiry Ni and the system configuration information Si related to the computer device 1 to an artificial intelligence (AI) engine 10, so that the artificial intelligence engine 10 generates a response output Ro according to the natural language inquiry Ni and the system configuration information Si. In this embodiment, the artificial intelligence engine 10 is disposed at a cloud, and is communicatively connected to the user interface 12 via the Internet (not shown), but the present disclosure is not limited thereto. In other embodiments, the artificial intelligence engine 10 can be located within the computer device 1. The artificial intelligence engine 10 is a server (or a server cluster) or a cloud server. The natural language inquiry Ni and the system configuration information Si received by the artificial intelligence engine 10 are in formats such as those shown in FIG. 3.

For example, the artificial intelligence engine 10 uses a Natural Language Understanding (NLU) technique of Natural Language Processing (NLP) to analyze the natural language inquiry Ni (that is, analyzing the intention of the question raised by the user) to generate a user intention (for example, “The USB keyboard does not function; do you have any suggestions to solve this problem?”). Next, the artificial intelligence engine 10 compares and analyzes the user intention and the system configuration information Si (for example, USB port utilization information in the computer device), so as to generate an analysis result (for example, “the USB port is not activated by the computer device”). Lastly, the artificial intelligence engine 10 generates the response output Ro (for example, “I found out that the USB port is not activated by the computer device. I have activated related settings of the USB port. Please reset the system and try again.”) by a Natural Language Generation (NLG) technique of NLP according to the analysis result.

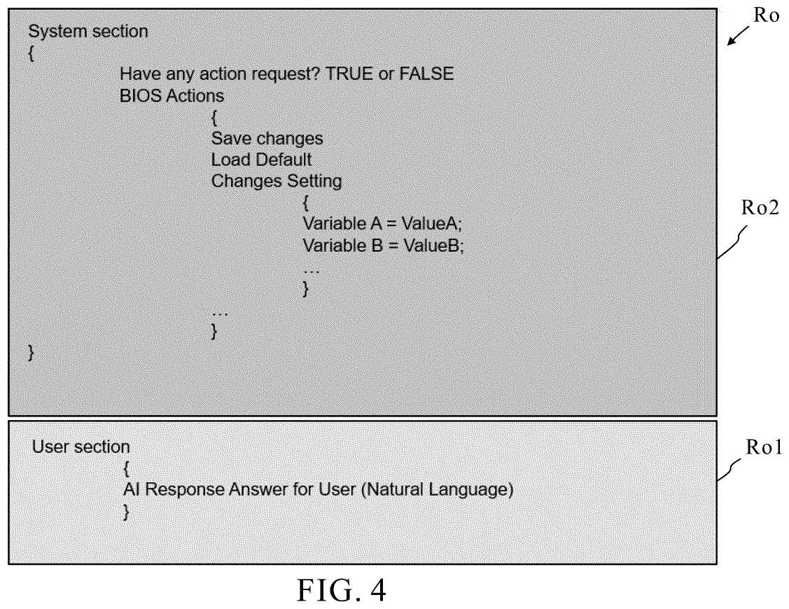

In step 23, the user interface 23 receives the response output Ro from the artificial intelligence engine 10. The response output Ro includes a natural language response field and/or a BIOS command field. The response output Ro is in a format as that shown in FIG. 4, wherein the denotation Ro1 represents the natural language response field and the denotation Ro2 represents the BIOS command field.

In step 24, the user interface 12 provides a natural language response (that is, “I found out that the USB port is not activated by the computer device. I have activated related settings of the USB port. Please reset the system and try again.”) in the natural language response field to the user, and executes a BIOS setting adjustment command in the BIOS command field (that is, activating related settings of the USB port) to adjust the BIOS setting, for example, through a Windows Management Instrumentation (WMI), a Device Firmware Configuration Interface (DFCI), changing a variable or a Human Interface Infrastructure (HII) Setup Data Hub. The natural language response is in a text, voice or graphic format. In other embodiments, the natural language response can be transmitted to another device outside the computer device 1. The natural language response and the BIOS setting adjustment command are generated in response to the natural language inquiry Ni. The adjusting of the BIOS setting is, for example, adjusting a boot order, an interface setting (for instance, a Serial Advanced Technology Attachment (SATA) setting), a Universal Serial Bus (USB) setting, a display setting, a wake-on-LAN setting, a central processing unit setting, a memory setting, or a power option setting. It should be noted that, in this embodiment, when the natural language inquiry Ni is a data inquiry about a BIOS setting adjustment inquiry, the response output Ro includes the natural language response field and the BIOS command field. When the natural language inquiry Ni is only a data inquiry related to the use of the computer device 1, the BIOS command field can be an empty field, or the response output Ro includes only the natural language response field. At this point in time, in step 24, only the natural language response in the natural language response field is provided to the user; however, the present disclosure is not limited to the example above. In other embodiments, the response output Ro can include only the BIOS command field.

As such, the BIOS setup service method performed by the computer device 1 can adjust all settings of the computer device 1 or acquire related inquiry data by a single natural language control means, and can adjust the BIOS settings to specifications required by the user, hence solving issues for the user. It should be noted that, regardless of an environment such as Power-On Self-Test (POST), SHELL or Operating System (OS) in which the BIOS is, the BIOS directly assists the user by communicating with the artificial intelligence engine 10 that is either trained or untrained.

The present disclosure further provides a computer program product including multiple instructions. The computer device 1, after reading the instructions, is enabled to perform the BIOS setup service method shown in FIG. 2 according to the embodiments above. In one embodiment, the computer program product includes a storage medium, for example, a non-transitory computer-readable storage medium having computer-readable instructions stored therein, for example, program codes, wherein the instructions are executed in at least one computer device to enable the at least one computer device to perform the BIOS setup service method above.

In conclusion, by performing the BIOS setup service method, the present disclosure enables a user to directly interact with the BIOS by the user interface 12 using a natural language, achieving control over all settings of the computer device 1 or acquiring related inquiry data by a single control means (natural language). Thus, a user is not required to adjust BIOS settings through a BIOS setting interface presented in the form of text/menu, hence preventing the issues of the prior art, further achieving an effect of providing a user with ease of use. Moreover, certain physically challenged users (for example, visually impaired users) are allowed to adjust the BIOS settings by using the user interface 12 to directly interact with the BIOS through a natural language using a natural language inquiry in a voice format, and acquire a natural language response output in a voice format from the user interface 12. Thus, issues or requirements of users with challenges are solved or fulfilled.

The present disclosure is described by way of the preferred embodiments above. A person skilled in the art should understand that, these embodiments are merely for illustrating the present invention, and are not to be construed as limitations to the scope of the present disclosure. It should be noted that all equivalent changes, replacements and substitutions made to the embodiments are encompassed within the scope of the present disclosure. Therefore, the legal protection for the present disclosure should be defined by the appended claims.

While the present disclosure has been described by means of specific embodiments, numerous modifications and variations could be made thereto by those skilled in the art without departing from the scope and spirit of the present disclosure set forth in the claims.

What is claimed is:

1. A Basic Input/Output System (BIOS) setup service method, performed by a computer device, the method comprising steps of:
(A) receiving a natural language inquiry from a user;
(B) providing the natural language inquiry and system configuration information related to the computer device to an artificial intelligence engine, so that the artificial intelligence engine generates a response output according to the natural language inquiry and the system configuration information;
(C) receiving the response output from the artificial intelligence engine, the response output comprising a natural language response field; and
(D) providing the user with a natural language response in the natural language response field.

2. The BIOS setup service method according to claim 1, wherein in step (C), the response output comprises the natural language response field and/or a BIOS command field, and step (D) further comprises executing a BIOS setting adjustment command in the BIOS command field to adjust a BIOS setting.

3. The BIOS setup service method according to claim 2, wherein in step (D), the BIOS setting is adjusted through a Windows Management Instrumentation (WMI), a Device Firmware Configuration Interface (DFCI), changing a variable or a Human Interface Infrastructure (HII) Setup Data Hub.

4. The BIOS setup service method according to claim 1, wherein in step (A), the natural language inquiry is in a text, voice, graphic or video format.

5. The BIOS setup service method according to claim 1, wherein in step (D), the natural language response is in a text, voice or graphic format.

6. The BIOS setup service method according to claim 1, wherein the natural language inquiry is a BIOS setting adjustment inquiry and/or a data inquiry related to use of the computer device.

7. The BIOS setup service method according to claim 1, wherein the system configuration information comprises BIOS information and/or Unified Extensible Firmware Interface (UEFI) information.

8. The BIOS setup service method according to claim 1, wherein the artificial intelligence engine is located within the computer device or is disposed at a cloud, and is a trained or untrained artificial intelligence engine.

9. The BIOS setup service method according to claim 1, wherein in step (D), the natural language response is transmitted to another device outside the computer device.

10. A computer device, comprising:
a BIOS, having system configuration information related to the computer device; and
a user interface, communicatively connected to the BIOS to acquire the system configuration information, and operable to perform the BIOS setup service method of claim 1.

11. A non-transitory computer-readable storage medium, having a plurality of instructions stored therein, wherein a computer device, after reading the plurality of instructions, is enabled to perform the BIOS setup service method of claim 1.
